(19) United States
(12) Patent Application Publication
(10) Pub. No.: US 2018/0249395 A1
(43) Pub. Date: Aug. 30, 2018

(54) ACCESS NETWORK SELECTION FOR A MULTI-ACCESS TERMINAL, BASED ON A PHEROMONE SIGNAL

(71) Applicant: ORANGE, Paris (FR)

(72) Inventor: Tahar MAMOUNI, Mezieres-Sur-Couesnon (FR)

(21) Appl. No.: 15/553,475

(22) PCT Filed: Feb. 24, 2016
(86) PCT No.: PCT/FR2016/050434

§ 371 Date: Aug. 24, 2017

(30) Foreign Application Priority Data
Feb. 27, 2015 (FR) 1551713

(51) Int. Cl. H04W 40/30; H04W 48/18; H04W 24/06

(52) U.S. Cl. CPC H04W 40/30; H04W 88/06; H04W 24/06; H04W 48/18

(57) ABSTRACT

Provided are a method for updating at least two tables and a method for transmission of a pheromone signal. The pheromone signal carries a series of pheromone messages transmitted at a constant frequency to a first terminal from a second terminal across each of the access networks of a plurality of access networks. The first terminal and the second terminal are connected in parallel by the plurality of access networks. A pheromone message of the series includes a single packet, the packet having an address of the first terminal relative to one access network of the plurality, via which the message is passed, triggers, when it is received by the first terminal, an updating of a table corresponding to the access network. This table is determinant for selection of an access network from the plurality, by one of the first or second terminals.

### 1. CROSS-REFERENCE TO RELATED APPLICATIONS

This Application is a Section 371 National Stage Application of International Application No. PCT/FR2016/050434, filed Feb. 24, 2016, the content of which is incorporated herein by reference in its entirety, and published as WO 2016/135424 on Sep. 1, 2017, not in English.

### 2. FIELD OF THE INVENTION

The invention lies in the field of multi-access terminals, that is to say those capable of connecting to several access networks which are of different technologies.

### 3. PRIOR ART

A multi-access terminal, for example a smartphone or a tablet, possesses several interfaces allowing it to connect simultaneously to several access networks, for example at one and the same time to a WiFi network and to a 4G network.

In order to profit from the bandwidth surfeit made possible by this simultaneous use of several access networks, the terminal must therefore distribute in a judicious manner over each of its interfaces the traffic that it sends or that it receives.

As a communication session remains on the same access network for the whole of its duration, the terminal must therefore distribute its sessions in the best way, which may be very numerous and above all in parallel. Moreover, this distribution must be adapted in real time to the state of each access network.

Before the start of a new session, the terminal must therefore choose the interface through which to establish the session. In order to optimize the bandwidth aggregated over all its interfaces, the terminal must make this choice as a function of the throughput necessary for the session, compared with the throughput remaining on each interface.

This makes it necessary to measure in real time the respective throughputs of the access networks, instantaneous and/or smoothed over one or more durations, it not being possible to do this at the level of the terminal without invoking management elements in the access networks concerned, and without specific messages for signaling to the terminals, which may number tens of thousands to be simultaneously connected to a given access network. Moreover, bandwidth estimation mechanisms are generally very unreliable, and not suitable for chance variations in radio conditions.

One of the aims of the invention is to remedy these drawbacks of the prior art.

### 4. SUMMARY

The invention improves the situation with the aid of a method for updating at least two tables corresponding respectively to at least two access networks linking in parallel a first terminal to a second terminal, the method comprising the following steps implemented by the first terminal:
reception of a message of a determined type, termed a pheromonal message, sent by the second terminal and having traveled through one of the at least two access networks,
analysis of the content of the pheromonal message received, comprising a step of detecting the determined type,
addition of a row corresponding to the pheromonal message to the table corresponding to the access network of travel of the pheromonal message received, as a function of the analysis.

By virtue of the invention, the first terminal, for example a multi-access terminal, that is to say a terminal having several interfaces allowing it to connect by choice or simultaneously to several different access networks, can at any instant select the access network having the throughput most suitable for its needs as regards reception, that is to say in the downgoing direction. Accordingly, it suffices for it to consult the tables and to select, for example, the access network whose table contains the most rows.

Indeed, at a given instant, the table with the largest number of rows corresponds to the access network through which the most messages destined for the multi-access terminal travel, this being indicative of a greater downgoing throughput relative to that of the other access networks, at least for these messages which are of a predetermined type, and at least for a period preceding the given instant.

By analogy with the pheromones deposited by ants to indicate to their congeners characteristics of the various known journeys between nest and food, these messages of determined type are hereinafter called “pheromonal messages”. By the same analogy, the counting of rows in the tables can be compared with a counting of deposited pheromones.

Thus, a terminal can select the access network most suitable for its needs as regards reception without it being necessary to measure the available throughput on each of the access networks.

It is understood that in order that the tables reflect in an objective manner the capacities of the access networks, it is preferable that the remote terminal sends the pheromonal messages to the multi-access terminal in a regular manner, by equitably servicing each of the access networks.

It is also understood that the remote terminal, that is to say that which sends the pheromonal messages, also has the possibility of selecting the access network most suitable for its needs as regards sending, without it being necessary to measure the throughput available on each of the access networks, on condition that it has access to the row counts of the various tables. This is particularly beneficial if the roles are reversed, that is to say if it is the multi-access terminal which sends the pheromonal messages, and it is the remote terminal which updates the counters.

According to one aspect of the invention, the method for updating at least two tables comprises, prior to the reception step, for each of the at least two access networks, at least one step of sending a message, termed the initial pheromonal message, to the second terminal, the initial pheromonal message traveling through said one of the at least two access networks, the sending step being repeated according to an identical frequency for the at least two access networks. According to this same aspect, the pheromonal message received has been sent by the second terminal in response to one of the initial pheromonal messages, the pheromonal message received and said one of the initial pheromonal messages having traveled through the same access network.

According to this aspect corresponding to a particular embodiment of the invention, the pheromonal messages perform an outbound-inbound trip from the multi-access terminal, rather than a simple outbound leg from the remote terminal. The multi-access terminal itself performs the regular sending of the pheromonal messages, called initial messages during the “outbound” journey, on each of its interfaces corresponding to the access networks. Thus, the function of the remote terminal is simplified since it now merely has to return each of the initial messages that it receives to the multi-access terminal as and when it receives them. In this particular embodiment of the invention, the behavior of the pheromonal messages is therefore close to that of the packets in TCP mode, where a packet received by a remote node is always acknowledged by the sending by the remote node of a corresponding acknowledgment message, in contradistinction to the packets in UDP mode for example, where a received packet is not acknowledged.

According to one aspect of the invention, the method for updating at least two tables comprises at least one step of deleting the row from the table, after expiry of a lifetime of the pheromonal message received.

By virtue of this aspect, the number of rows in a table, analogous to a counting of pheromones deposited by one of the access networks, is corrected when pheromonal messages have become too old. This reflects the availability of the access networks over a precise duration that it is possible to adapt to suit the time scale of the communication sessions which are established on these access networks, instead of reflecting an availability which, otherwise, would be smoothed over an undefined period and which might be too long to be useful in the time scale of the communication sessions.

According to one aspect of the invention, the analysis step comprises a step of determining a remaining lifetime of the pheromonal message, at the moment of the reception step, and the step of adding a row to the table is performed if the remaining lifetime has not expired.

By virtue of this aspect, a table does not take account of a pheromonal message if it has already expired at the moment of its reception. This may be the case if the remaining lifetime of the pheromonal message begins to decrease before the moment of its reception.

According to one aspect of the invention, the remaining lifetime of the pheromonal message begins to decrease at the moment of its sending by the second terminal, and where the pheromonal message comprises an item of information relating to the moment of its sending.

By virtue of this aspect, a table takes account exactly of the time that a pheromonal message takes to cover the complete journey between the sender terminal and the receiver terminal, including its journey time in the access network traversed. The item of information relating to the moment of its sending is for example a time-stamp performed in a field of the message by the sender terminal at the moment of the sending of the pheromonal message.

According to one aspect of the invention, the remaining lifetime of the pheromonal message begins to decrease at the moment of the reception step.

By virtue of this aspect, the pheromonal message does not need to comprise an item of information relating to the moment of its sending, thereby shortening the message and simplifying the sender side and receiver side processings.

Indeed, on condition one chooses an initial remaining lifetime that is greater than the journey time whichever the access network traversed, the tables reflect the throughputs of the access networks relative to one another, without needing to take account of the exact journey time.

According to one aspect of the invention, the initial remaining lifetime is the same for all the pheromonal messages.

By virtue of this aspect, the pheromonal messages have an identical initial lifetime whichever access network they traverse on their journey, thus implying that no access network is favored by its table to the detriment of another.

According to one aspect of the invention, the method for updating at least two tables furthermore comprises a step of counting the number of row per table, and a step of selecting one of the at least two access networks as a function of the counting.

By virtue of this aspect, if the terminal must increase its downgoing throughput, for example by opening a new communication session especially consuming in the so-called “download” direction, it can use the indications, provided by the counting, of relative downgoing throughputs to select the access network most suitable for its needs, and to avoid overloading less suitable access networks.

According to one aspect of the invention, the method for updating at least two tables furthermore comprises a step of counting the number of row per table, and a step of sending an item of information relating to the counting, destined for the second terminal.

By virtue of this aspect, the remote terminal, that is to say that which sends the pheromonal messages, has access to the counting performed by the terminal receiving and analyzing the pheromonal messages, and can select the access network most suitable for its own needs as regards sending, in the so-called “upload” direction for it.

This step of sending an item of information relating to the counting can be performed either on the spot on request, or automatically in a regular manner, for example following a request for subscription specific to such an item of information.

The spot request or subscription request may come directly from the second terminal, or come from a network management element controlled by a telecommunication network or service operator, such as a mobile operator or an Internet access provider, of which the user of the second terminal is a subscriber.

The various aspects of the method for updating a plurality of tables which have just been described may be implemented independently of one another or in combination with one another.

The invention also relates to a method for sending a pheromonal message destined for a first terminal, implemented by a second terminal, the first terminal and the second terminal being linked in parallel by at least two access networks, the method comprising, for each of the at least two access networks, at least one step of sending the pheromonal message to the first terminal, the pheromonal message traveling through said one of the at least two access networks, the sending step being repeated according to an identical frequency for the at least two access networks.

With respect to the first terminal, the pheromonal messages are sent from a point upstream of the access networks, by the second terminal. The pheromonal messages are sent all in turn via each of the access networks, and the frequency of sending the messages is identical for all the interfaces.

As the travel conditions may differ between these access networks, the pheromonal messages are not received by the first terminal at the same tempo as they are sent. Thus, the first terminal can deduce useful information on the respective throughputs of the access networks, in the downgoing direction, simply by counting the pheromonal messages received via the various access networks.

In order that a pheromonal message does indeed traverse the access network envisaged, its destination address must be specific to this access network.

According to one aspect of the invention, the method for sending a pheromonal message furthermore comprises a prior step of receiving a request for subscription to the pheromonal messages for the first terminal.

By virtue of this aspect, it is possible to control the triggering of the sending of the pheromonal messages for a given terminal. The request for subscription can comprise destination addresses of the first terminal corresponding to the various access networks, or simply an identifier of the first terminal making it possible to obtain these addresses, such as a subscription number specific to the first terminal.

The request may come directly from the first terminal, or come from a network management element controlled by a telecommunication network or service operator, such as a mobile operator or an Internet access provider, of which the user of the first terminal is a subscriber.

The invention also relates to a method of returning a pheromonal message to a first terminal, implemented by a second terminal, the first terminal and the second terminal being linked in parallel by at least two access networks, the method comprising a step of receiving the pheromonal message originating from the first terminal, and a step of returning the pheromonal message to the first terminal, the pheromonal message received and the pheromonal message returned traveling through the same access network.

Thus, it is possible to implement in the first terminal at one and the same time the method for sending a pheromonal message according to the invention, and the method for updating at least two tables according to the invention. The second terminal is thereby simplified since it performs only a simple operation of returning messages.

According to one aspect of the returning method, the reception step is followed, prior to the returning step, by a step of time-stamping the pheromonal message. Thus, it is possible for the first terminal to take into account the duration of the “return” journey of the pheromonal message.

The invention also relates to a pheromonal signal carrying a string of pheromonal messages sent at constant frequency destined for a first terminal originating from a second terminal through each of the access networks of a plurality of access networks, the first terminal and the second terminal being linked in parallel by the plurality of access networks. Each pheromonal message of the string comprises a single packet, the packet comprising an address of the first terminal relating to an access network of the plurality, through which the message travels. Moreover, each pheromonal message triggers, when it is received by the first terminal, the updating of a table corresponding to the access network, the table being determining for the selection of an access network of the plurality, by one of the first or second terminals.

The pheromonal signal according to the invention triggers precise actions in the terminal which receives it. Each pheromonal message that it contains is composed of a single packet, for example an ICMP packet, thereby avoiding causing crowding of the access networks. The actions triggered by each pheromonal message allow the terminal to achieve a counting which is representative of the relative bandwidth of each of the access networks, in the downgoing direction.

According to one aspect of the pheromonal signal according to the invention, the packet furthermore comprises a field indicating the moment of its sending by the second terminal.

By virtue of this aspect, each pheromonal message that the signal contains allows the first terminal to calculate the transmission speed, in the downgoing direction, of the access network traversed by the pheromonal message received.

The invention also relates to a first terminal connected to a plurality of access networks linking it in parallel to a second terminal, said first terminal comprising:
a plurality of tables corresponding to the plurality of access networks,
a module for receiving a message of a determined type, termed a pheromonal message, sent by the second terminal and having traveled through one of the access networks of the plurality,
a module for analyzing the content of the pheromonal message received,
a module for adding a row to the table corresponding to the access network of travel of the pheromonal message received, as a function of the analysis.

Such a first terminal according to the invention can be a user terminal such as a “smartphone”, a tablet, a laptop computer or any other terminal able to connect simultaneously to different access networks through specific interfaces, for example WiFi, 3G, 4G, etc.

Alternatively, such a first terminal can be a server on the Internet network, able to distinguish the access network via which the messages that it receives from another terminal have traveled, for example with the aid of the identifier used by this other terminal.

The first terminal according to the invention is able to implement in all its embodiments the method for updating a plurality of counters which has just been described.

The invention also relates to a second terminal connected to a plurality of access networks linking it in parallel to a first terminal, said second terminal comprising a sending module able to send a pheromonal message to the first terminal through each of the access networks of the plurality, the sending module being able to repeat the sending according to an identical frequency for the access networks of the plurality.

Such a second terminal according to the invention can be any element situated upstream of the access networks, with respect to the first terminal which receives the pheromonal messages.

It can be a server on the Internet network, if the first terminal is a user terminal. Alternatively, it can be a user terminal, if the first terminal is a server on the Internet.

The second terminal according to the invention is able to implement in all its embodiments the method for sending a pheromonal message which has just been described.

The invention further relates to a computer program comprising instructions for the implementation of the steps of the method for updating at least two tables which has just been described, when this program is executed by a processor.

The invention also relates to a recording medium readable by a user terminal or by a server on the Internet, on which is recorded the program which has just been described, being able to use any programming language, and be in the form of source code, object code, or of code intermediate between source code and object code, such as in a partially compiled form, or in any other desirable form.

The invention also relates to a computer program comprising instructions for the implementation of the steps of the method for sending a pheromonal message which has just been described, when this program is executed by a processor.

The invention relates finally to a recording medium readable by a server on the Internet or by a user terminal, on which is recorded the program which has just been described, being able to use any programming language, and be in the form of source code, object code, or of code intermediate between source code and object code, such as in a partially compiled form, or in any other desirable form.

### 5. PRESENTATION OF THE FIGURES

Other advantages and characteristics of the invention will become more clearly apparent on reading the following description of a particular embodiment of the invention, given by way of simple illustrative and nonlimiting example, and the appended drawings, among which:

FIG. 1 presents in a schematic manner a first terminal and a second terminal implementing the method for updating at least two counters and the method for sending a pheromonal message, according to one aspect of the invention,

FIG. 2 presents an exemplary structure of a pheromonal message, according to one aspect of the invention,

FIG. 3 presents an exemplary implementation of the method for updating at least two tables and of the method for sending a pheromonal message, according to a first embodiment of the invention,

FIG. 4 presents an exemplary implementation of the method for updating at least two tables and of the method for sending a pheromonal message, according to a second embodiment of the invention,

FIG. 5 presents an exemplary structure of a first terminal, implementing the method for updating at least two tables, according to one aspect of the invention,

FIG. 6 presents an exemplary structure of a second terminal, implementing the method for sending a pheromonal message, according to one aspect of the invention.

### 6. DETAILED DESCRIPTION OF AT LEAST ONE EMBODIMENT OF THE INVENTION

In the subsequent description, examples are presented of several embodiments of the invention based on a multi-access terminal able to connect simultaneously to a WiFi network and to a 4G network, but the invention also applies to other multi-access terminals and to other access networks.

The invention applies for example to a residential gateway (or “home gateway”) capable of establishing a connection to a 4G network, in addition to its xDSL connection, or to a personal computer equipped with Ethernet connectivity, with WiFi connectivity and/or with 4G connectivity.

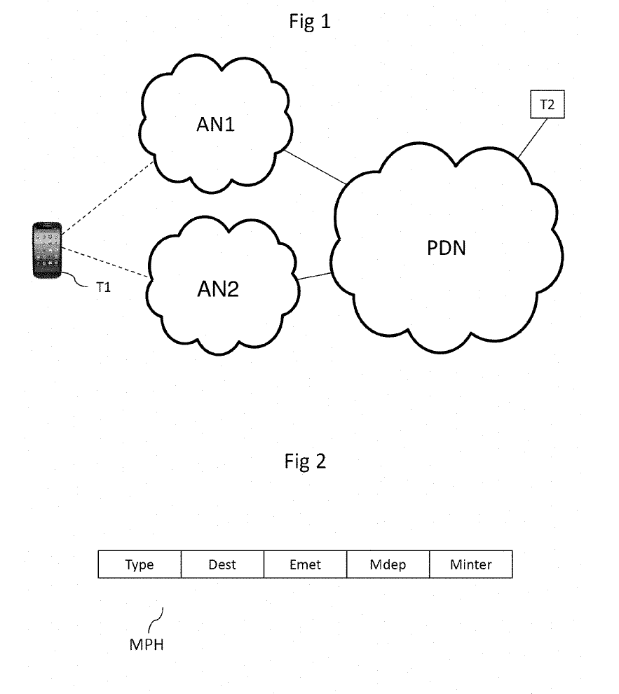

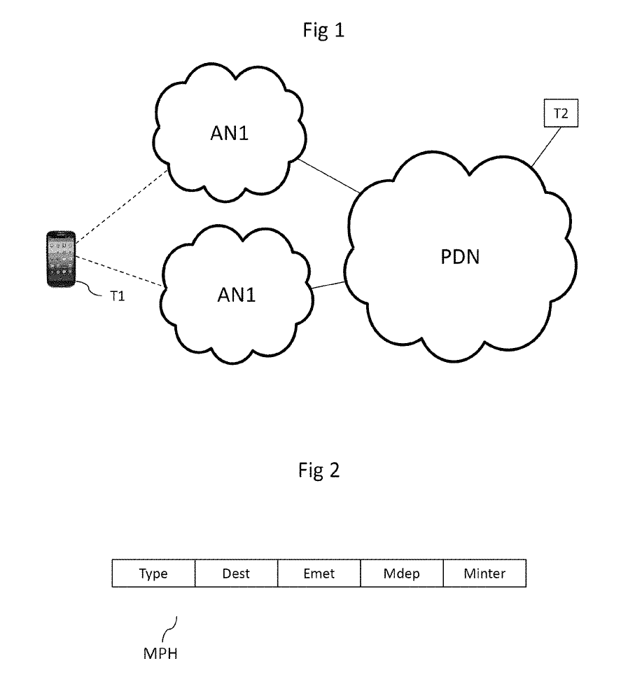

FIG. 1 presents in a schematic manner a first terminal and a second terminal implementing the method for updating at least two counters and the method for sending a pheromonal message, according to several aspects of the invention.

The terminal T1 is a multi-access terminal, that is to say that it can establish simultaneous communication sessions by using several access technologies at one and the same time, for example WiFi technology, according to the standards of the IEEE 802.11 family, and 4G technology, according to the standards of the 3GPP LTE family.

The access network AN1 is for example a local area network comprising WiFi compatible access points. The access network AN2 is for example a cellular network comprising 4G compatible base stations.

Both the access networks AN1 and AN2 allow the terminal T1 to connect to other remote elements connected to a packet switching PDN network, such as for example the Internet network.

The terminal T2 is a remote element connected to the PDN network. The terminals T1 and T2 can exchange between themselves messages consisting of one or more packets.

According to a first embodiment of the invention, the terminal T1 evaluates the bandwidth available for it on the networks AN1 and AN2 with the aid of special messages, called pheromonal messages, sent by the terminal T2. The terminal T2 sends these pheromonal messages to the terminal T1 by traversing the networks AN1 and AN2 in turn, and these sends are repeated a large number of times according to a regular frequency which is identical for AN1 and AN2, so as to form a string of pheromonal messages, called a pheromonal signal. If one of the two networks has a greater throughput than the other, the messages will accumulate more quickly on arrival in the terminal T1 via this access network. By counting the number of messages received via each of the access networks AN1 and AN2 in tables corresponding respectively to these access networks, the terminal T1 can therefore detect which of the two access networks offers the largest throughput for it, this being very useful if it is on the point of opening a new communication session with a remote element connected to the Internet (not illustrated). The terminal T1 will be able to select the access network which is most suitable at that moment.

According to this first embodiment, it is understood that the tables reflect the relative throughputs of the access networks in the downgoing direction toward the terminal T1.

According to a variant of the first embodiment, the roles are reversed between the terminals T1 and T2, and it is the terminal T1 which sends the pheromonal signal to the terminal T2. The terminal T2 counts the messages in tables on arrival. The tables then reflect the relative throughputs of the access networks in the downgoing direction toward the terminal T2, that is to say the upgoing direction from the terminal T1. In order for the terminal T1 to be able to select the access network which is most suitable for a new communication session using the upgoing direction predominantly, it must have access to the tables updated by the terminal T2, at the very least to the number of rows per table. The terminal T2 therefore sends the terminal T1 a special message relating to these tables.

According to a second embodiment, the terminal T1 sends the pheromonal signal to the terminal T2, which returns each pheromonal message to the terminal T1, after having possibly time-stamped it before its resending. On its inbound leg, each pheromonal message traverses the same access network as it traversed on the outbound leg.

Thus, by counting the messages received by return, the terminal T1 has evaluations of the relative throughputs both in the downgoing direction and in the upgoing direction. In this embodiment, it is the same terminal which performs the sending of the pheromonal signal and the counting of the pheromonal messages in tables. The other terminal merely returns the messages of the pheromonal signal, optionally applying a time-stamp to them.

According to a variant of the second embodiment, the roles are reversed between the terminals T1 and T2, the terminal T2 which sends the pheromonal signal, and the terminal T1 returns it.

In order to limit the growth of the tables for each of the access networks, an identical initial lifetime D is allotted to all the pheromonal messages. The moment at which the remaining lifetime begins to decrease can be adjusted to the moment of reception of the pheromonal message, or to the moment of its sending, in any of the embodiments. This may also be, in the second mode, after the outbound leg, at the intermediate moment before the message is re-sent before the inbound leg. When the lifetime of a message reaches expiry, its row is subtracted from the corresponding table. Thus, not only do the tables not increase in size indefinitely, but it is possible to adjust the initial lifetime D of the pheromonal messages as a function of the duration over which it is desirable to smooth the measurements of relative throughputs, for example so as to establish a relationship between the tables and the average duration of use of the terminal. The TCP protocol has performance levels related to the return trip time RTT of an IP packet, and to the packet loss rate on the link. For example, a max throughput of 20 Mb/s is observed for an RTT of 40 ms and packet losses of 0.01%. In this example if the 2 accesses have this order of magnitude in terms of throughput and latency, we can take:

D=80 ms,

that is to say twice the value of an average RTT.

FIG. 2 presents an exemplary structure of a pheromonal message, according to one aspect of the invention.

A pheromonal message MPH must comprise at the minimum a Type field indicating that it is a message of pheromonal type, and a Dest field indicating the address of the recipient terminal. If the recipient terminal cannot determine which access network has been traversed by the message, and therefore which of the tables to update, or which of the access networks the pheromonal message to be returned must traverse, then a Emet field indicating the address of the sender terminal must also be included. Such is for example the case for the terminal T2 in the variant of the first embodiment or in the second embodiment that were described hereinabove, since it is not connected directly to the access networks, and cannot identify the access network that was traversed by a pheromonal message received when the terminal T1 is the one which sends the pheromonal signal. On the other hand, this is pointless the other way round, as in the case of the first embodiment described hereinabove, since the terminal T1 knows on which of its access network interfaces (WiFi or 4G) it receives each pheromonal message, since it is directly connected to these access networks.

Optionally, the pheromonal message MPH can also comprise a Mdep field indicating its moment of departure, and/or, if the message performs an outbound-inbound trip as in the second embodiment described hereinabove, a Minter field indicating the intermediate moment between the outbound leg and the inbound leg.

A pheromonal message may for example be a particular type of ICMP (Internet Control Message Protocol) packet, according to standard RFC792 (in IPv4) or standard RFC4443 (in IPv6). The Emet and Dest fields described hereinabove can be the “source IP address” and “destination IP address” fields of an ICMP packet. The other fields described hereinabove, including the Type field, can be included in the “data” field of an ICMP packet.

Optionally, the pheromonal message MPH can also include a Sens field, two possible values of which make it possible to distinguish the “outbound” direction from the “return” direction. This is useful when a terminal operates both in the first and the second embodiment, and if the direction is “outbound”, if it must return the pheromonal message received, as a function of the identity of the remote terminal.

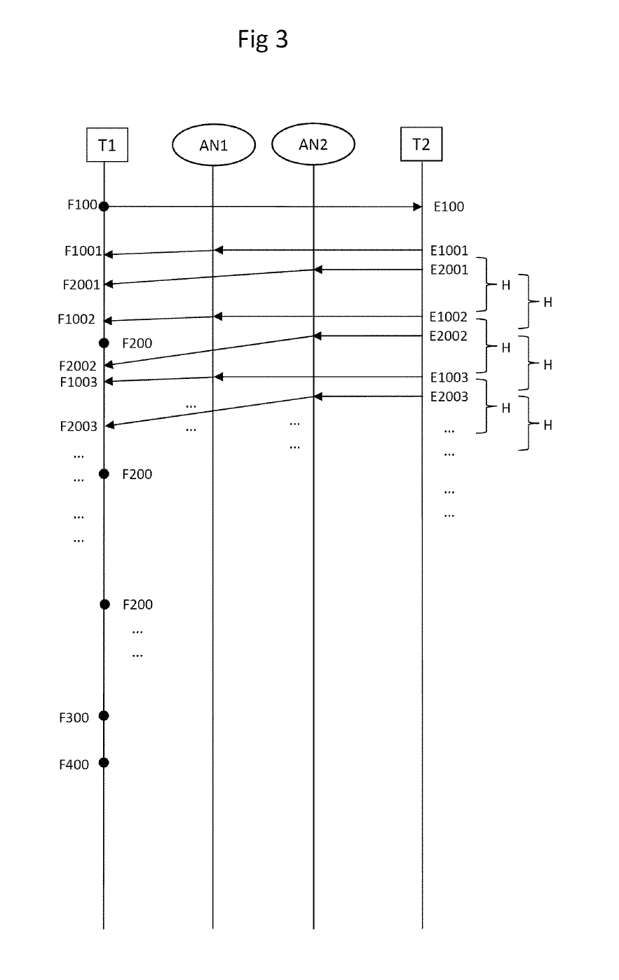

FIG. 3 presents an exemplary implementation of the method for updating at least two tables and of the method for sending a pheromonal message, according to the first embodiment of the invention.

During a step E100, a subscription request to receive a pheromonal signal is received by the terminal T2.

This request may have been sent in the course of a step F100 by the terminal T1 itself, traveling through one or the other of the networks AN1 or AN2, or it may have been sent by an arbitrary network element, managed by an operator of which the user of the terminal T1 is a subscriber.

The subscription request comprises an address of the terminal T1 that relates to the network AN1 and an address of the terminal T1 that relates to the network AN2, so that the terminal T2 sending the pheromonal signal is able to decide through which network AN1 or AN2 each of the pheromonal messages intended for the terminal T1 should be made to travel.

During a step E1001, the terminal T2 sends a pheromonal message MPH1001 destined for the terminal T1 by using the address of T1 that relates to the network AN1. The message MPH1001 comprises a Type field indicating that it is a message of pheromonal type, and a Dest field comprising said address of T1 on AN1. Optionally, it also comprises a Mdep field comprising an indication of the moment of departure of the message MPH1001.

Step E1001 is repeated after a time interval equal to H, during a step E1002, where a message MPH1002 identical to MPH1001, except for, if appropriate, the Mdep field which indicates the moment of departure of the message MPH1002 and not of the message MPH1001.

This sending step is thus repeated every interval H, during steps E1001, E1002, E1003, etc.

Likewise, during a step E2001, the terminal T2 sends a pheromonal message MPH2001 destined for the terminal T1 by using the address of T1 that relates to the network AN2. The message MPH2001 comprises a Type field indicating that it is a message of pheromonal type, and a Dest field comprising said address of T1 on AN2. Optionally, it also comprises a Mdep field comprising an indication of the moment of departure of the message MPH2001.

Step E2001 is repeated after a time interval equal to H, during a step E2002, where a message MPH2002 identical to MPH2001, except for, if appropriate, the Mdep field which indicates the moment of departure of the message MPH2002 and not of the message MPH2001.

This sending step is thus repeated every interval H, during steps E2001, E2002, E2003, etc.

It is important to note that the repetition interval H has the same value for steps E1xxx, and for steps E2xxx. Stated otherwise, whatever the access network through which the pheromonal messages travel, they are sent at the same frequency.

During a reception step F1001, the terminal T1 receives the message MPH1001 on its connection interface connected to the network AN1, at a moment Mrec1001.

During an analysis step F1001a, the terminal T1 detects that the message MPH1001 is a pheromonal message, by virtue of its Type field.

During an addition step F1001b, performed if the message received is a pheromonal message, the terminal T1 adds a row corresponding to the message MPH1001 to a table TAN1. This row comprises at least one cell whose value is initialized to the value of the moment Mrec1001.

An initial lifetime D is allotted to the row thus added, and the remaining lifetime of the row begins to decrease at the moment Mrec1001 of reception of the message MPH1001. A row of the table is analogous to a pheromone, and its lifetime to that of a pheromone, all the pheromones having the same lifetime. The regular cleaning of the table TAN1 will bring about the deletion of those of the rows whose lifetime has elapsed. If at the moment Mactuel of cleaning,

Mrec1001+D>Mactuel,

then the row is deleted, during a deletion step F200.

It is important to note that this initial lifetime D is identical for all the rows of all the tables.

During a step F1001c following step F1001b, the message MPH1001 is destroyed.

Steps similar to steps F1001, F1001a, F1001b and F1001c are performed for each of the pheromonal messages received by the terminal T1 on its connection interface connected to the network AN1, that is to say for each of the corresponding reception steps F1002, F1003, . . .

Likewise, steps F2xxx, F2xxxa, F2xxxb and F2xxxc are performed for each of the pheromonal messages received by the terminal T1 on its connection interface connected to the network AN2.

In an optional case, the counting of the lifetime remaining to a row is triggered starting from the moment indicated by the Mdep field. The advantage of this is to prevent a table from being filled with rows when the journey time through the access network of this table is abnormally long.

In this case, the terminal T1 does not necessarily perform step F1xxxb (respectively F2xxxb) of adding a row to the table TAN1 (resp. TAN2), if the difference between Mrec1xxx (resp. Mrec2xxx) and the value of the Mdep field of the message MPH1xxx (resp. MPH2xxx) is less than or equal to D. Stated otherwise, no row corresponding to MPH1xxx (resp. MPH2xxx) is added to the table TAN1 (resp. TAN2) if the initial lifetime D has already expired at the moment of reception of the message MPH1xxx (resp. MPH2xxx). On the other hand, if the row is added, the regular cleaning of the table TAN1 (resp. TAN2) will bring about the deletion of those of the rows whose lifetime has elapsed, according to a different calculation: if at the moment Mactuel of cleaning,

Mdep1xxx+D>Mactuel

(resp.: Mdep2xxx+D>Mactuel),

then the row is deleted, during the deletion step F200.

During the above-mentioned deletion step F200, a row of a table is therefore deleted if the duration that has elapsed from the moment indicated by the value of the cell is greater than or equal to D. This step can be implemented in a cycle of so-called “cleaning” of the tables, where each row of each table is examined one after the other, and the remaining lifetime verified. The cleaning cycle recommences once it has terminated, immediately or after a pause. Preferably, the lag between 2 cleaning cycles is of the same order of magnitude as the lifetime D. For a lifetime D of 80 ms, for example, the lag between 2 cleaning cycles can be 80 ms.

During a counting step F300, the number of rows NB1 of the table TAN1 and the number of rows NB2 of the table TAN2 are counted. This step F300 can be triggered when the terminal T1 is on the point of establishing a new communication session that may use either the network AN1, or the network AN2. Step F300 can also be performed periodically in an anticipated manner.

During a selection step F400, the terminal T1 selects the network AN1 or the network AN2 with a view to establishing a new communication session, based on NB1 and NB2. This selection is for example based on a calculation of what is called by analogy a rate of pheromones of each of the access networks AN1 and AN2. The rate of pheromones TPH1 of the network AN1 is:

TPH1=NB1/(NB1+NB2),

and the rate of pheromones TPH2 of the network AN2 is:

TPH2=NB2/(NB1+NB2).

The selection of an access network for a new communication session can thus be chosen in such way that the distribution of all the communication sessions of the terminal T1 on the two access networks approaches the distribution of the “pheromones”.

According to this first embodiment, it is understood that the tables reflect the relative throughputs of the access networks in the downgoing direction toward the terminal T1, and the selection performed in respect of an access network is relevant for this direction. If the determining direction of a new communication session to be established is the upgoing direction, it is possible to envisage the variant of the first embodiment, where the roles are reversed between the terminals T1 and T2. Everything happens in a symmetric manner to what has just been described, except for the following two differences.

Firstly, as the terminal T2 does not have access directly to the networks AN1 and AN2, each pheromonal message sent by the terminal T1 also comprises a Emet field indicating the address of the terminal T1 on the access network traversed (AN1 or AN2). This allows the terminal T2 to distinguish the pheromonal messages that have traveled through the network AN1 from those that have traveled through the network AN2.

Secondly, as it is the terminal T1 which must perform an access network selection, but it is not the one which performs the counting of “pheromones”, it needs an item of information relating to the counting performed by the terminal T2. The terminal T2 therefore transmits the counting of the rows NB1 and NB2 to it in a specific message.

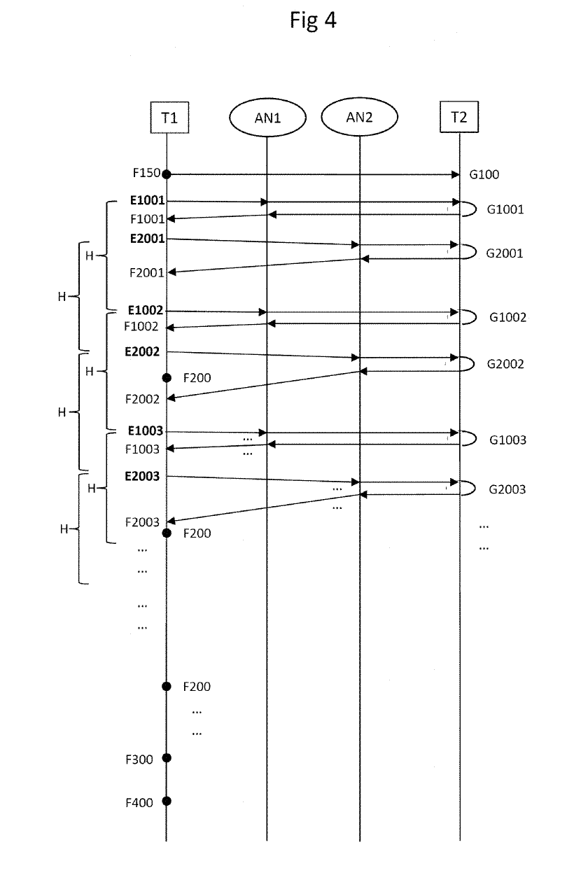

FIG. 4 presents an exemplary implementation of the method for updating at least two tables and of the method for sending a pheromonal message, according to the second embodiment of the invention.

It is recalled that in this mode, each pheromonal message performs an outbound-inbound trip by traversing on the inbound leg the same access network as it has traversed on the outbound leg.

During a step G100, a subscription request to receive a pheromonal signal is received by the terminal T2.

This request may have been sent in the course of a step F150 by the terminal T1 itself, traveling through one or the other of the networks AN1 or AN2, or it may have been sent by an arbitrary network element, managed by an operator of which the user of the terminal T1 is a subscriber. This subscription request differs from that described with reference to step E100 of FIG. 3 in that it instructs the terminal T2 to return the pheromonal messages that it receives to the addresses which sent them.

Steps E1xxx and steps E2xxx are identical to those described with reference to FIG. 3, except that they are performed by the terminal T1, and not the terminal T2. It is important to recall that the interval H of repetition of the sending of the pheromonal messages has the same value for steps E1xxx, and for steps E2xxx. Stated otherwise, whatever the access network through which the pheromonal messages travel, they are sent at the same frequency.

During steps G1xxx (and G2xxx), the terminal T2 receives the pheromonal messages MPH1xxx (and MPH2xxx) sent by the terminal T1, and returns them modified to the terminal T1. The modification of a pheromonal message consists at the minimum in swapping the values of the Emet and Dest fields. Thus, each pheromonal message returns to the terminal T1, traversing the same access network, AN1 or AN2, on the inbound leg as it traversed on the outbound leg.

Optionally, the modification performed by the terminal T2 also comprises either the updating of the Mdep field with the time-stamp of the moment of return of the pheromonal message by the terminal T2, or the use of another field, the Minter field, to hold the value of this time-stamp.

The steps of receiving a pheromonal message by the terminal T1, that is to say steps F1xxx and F2xxx, are identical to those described with reference to FIG. 3.

The steps of analyzing the pheromonal message by the terminal T1, that is to say steps F1xxxa, and F2xxxa, are identical to those described with reference to FIG. 3.

The steps of adding a row to the table TAN1 or TAN2 by the terminal T1, that is to say steps F1xxxb, and F2xxxb, are identical to those described with reference to FIG. 3.

The steps of destroying the pheromonal message by the terminal T1, that is to say steps F1xxxc, and F2xxxc, are identical to those described with reference to FIG. 3.

The steps F200 of deletion, F300 of counting and F400 of selection, are identical to those described with reference to FIG. 3.

According to this second embodiment, it is understood that the tables TAN1 and TAN1 reflect the relative throughputs of the access networks, in both transmission directions at the same time, downgoing and upgoing toward the terminal T1.

According to a variant of this second embodiment, it is also possible to distinguish the two directions of transmission, by taking advantage of the time-stamps held in the pheromonal messages with the Mdep and Minter fields. Indeed, during the step of adding a row to a table, it is possible to correct the remaining lifetime of the “pheromone” corresponding to a pheromonal message MPHyxxx, by deducting therefrom either the duration of the “outbound” journey, or that of the “return” journey. The duration of the “outbound” journey is the difference between the value Minteryxxx of the Minter field and the value Mdepyxxx of the Mdep field. The duration of the “return” journey is the difference between the moment Mrecyxxx of reception of the message MPHyxxx, and the value Minteryxxx of the Minter field. It is therefore possible to use two distinct tables for each of the access networks, a first table for the downgoing direction where it is the duration of the “outbound” journey that is deducted, and a second table for the upgoing direction where it is the duration of the “return” journey that is deducted.

When it is the duration of the “outbound” journey that must be deducted, the regular cleaning of a table will bring about the deletion of those of the rows whose lifetime has elapsed, during the deletion step F200, if at the moment Mactuel of cleaning,

Mrecyxxx+D−(Minteryyy−Mdepyxxx)>Mactuel

When it is the duration of the “return” journey that must be deducted, the regular cleaning of a table will bring about the deletion of those of the rows whose lifetime has elapsed, during the deletion step F200, if at the moment Mactuel of cleaning,

Mrecyxxx+D−(Mrecyxxx−Minteryyy)>Mactuel, that is to say,

D+Minteryyy>Mactuel

Other calculation schemes are possible, for example by making the life of a pheromonal message start at the moment of its departure, or of its half-lap, rather than at the moment of its return.

An exemplary structure of a first terminal, implementing the method for updating at least two tables, according to one aspect of the invention is now presented in conjunction with FIG. 5.

The first terminal 100 implements the method for updating at least two tables, various embodiments of which have just been described. Such a terminal 100 can be a smartphone, a tablet, a laptop computer or any other terminal able to connect simultaneously to different access networks through specific interfaces, for example WiFi, 3G, 4G, etc.

For example, the terminal 100 comprises a processing unit 130, equipped for example with a microprocessor μP, and driven by a computer program 110, stored in a memory 120 and implementing the method for updating at least two tables according to the invention, and optionally the method for sending a pheromonal message according to the invention. On initialization, the code instructions of the computer program 110 are for example loaded into a RAM memory, before being executed by the processor of the processing unit 130.

Such a terminal 100 comprises:
at least two tables TAN1 and TAN2, corresponding respectively to at least two access networks AN1 and AN2,
a reception module 140, able to receive a pheromonal message (MPH), originating from a second terminal,
an analysis module 150, able to analyze the pheromonal message received, the analysis comprising a detection of the type of the message, a detection of the access network traversed by the message,
an addition module 160, able to add, as a function of the analysis, a row corresponding to the pheromonal message to the table corresponding to the access network traversed,
a deletion module 170, able to delete a row from a table, after expiry of a lifetime,
a counting module 180, able to count the number of rows per table,
a selection module 190, able to select, as a function of the counting, one of the access networks, through which a new communication session must be established.

Advantageously, the terminal 100 can also comprise:
a sending module 195, able to send an item of information (iPH) relating to the counting, destined for a second terminal able to select, as a function of the counting, one of the access networks, through which a new communication session must be established,
a sending module 135, able to send a request for subscription (sub) to a pheromonal signal carrying pheromonal messages, destined for a second terminal.

Advantageously, the terminal 100 can also comprise:
a sending module 200, able to send a pheromonal message (MPH) to a second terminal, the message being part of a pheromonal signal (SPH) consisting of a string of pheromonal messages sent repeatedly at identical intervals while traversing each of the access networks.

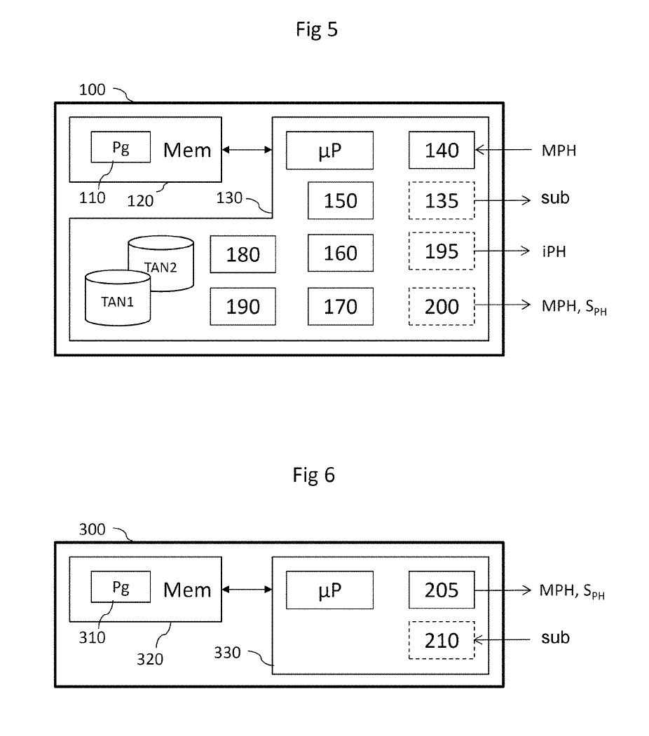

An exemplary structure of a second terminal, implementing the method for sending a pheromonal message, according to one aspect of the invention is now presented in conjunction with FIG. 6.

The second terminal 300 implements the method for sending a pheromonal message, various embodiments of which have just been described. Such a terminal 300 can be any element situated upstream of the access networks, with respect to the first terminal which receives the pheromonal messages. The terminal 300 may be for example a server on the Internet network.

For example, the second terminal 300 comprises a processing unit 330, equipped for example with a microprocessor μP, and driven by a computer program 310, stored in a memory 320 and implementing the method for updating at least two tables according to the invention, and optionally the method for sending a pheromonal message according to the invention. On initialization, the code instructions of the computer program 310 are for example loaded into a RAM memory, before being executed by the processor of the processing unit 330.

Such a second terminal 300 comprises:
a sending module 205, able to send a pheromonal message (MPH) to a first terminal, the message being part of a pheromonal signal (SPH) consisting of a string of pheromonal messages sent repeatedly at identical intervals while traversing each of the access networks.

Advantageously, the second terminal 300 can also comprise:
a reception module 210, able to receive originating from a first terminal a request for subscription (sub) to a pheromonal signal carrying pheromonal messages.

The modules described in conjunction with FIGS. 5 and 6 can be hardware modules or software modules.

The exemplary embodiments of the invention which have just been presented are merely a few of the conceivable embodiments. They show that the invention allows a multi-access terminal to select the access network most suitable for its needs as regards reception or sending, without it being necessary to measure the throughputs available on each of the access networks, in either direction.

Although the present disclosure has been described with reference to one or more examples, workers skilled in the art will recognize that changes may be made in form and detail without departing from the scope of the disclosure and/or the appended claims.

1. A method for updating at least two tables corresponding respectively to at least two access networks linking in parallel a first terminal to a second terminal, the method comprising the following acts implemented by the first terminal:
reception of a message of a determined type, termed a pheromonal message, sent by the second terminal and having traveled through one of the at least two access networks,
analysis of the content of the pheromonal message received, comprising detecting the determined type, and
addition of a row corresponding to the pheromonal message to the table corresponding to the access network of travel of the pheromonal message received, as a function of the analysis.

2. The method for updating at least two tables as claimed in claim 1, comprising, prior to the reception act:
for each of the at least two access networks,
at least one act of sending a message, termed an initial pheromonal message, to the second terminal, the initial pheromonal message traveling through said one of the at least two access networks,
the sending act being repeated according to an identical frequency for the at least two access networks,
and where the pheromonal message received has been sent by the second terminal in response to one of the initial pheromonal messages, the pheromonal message received and said one of the initial pheromonal messages having traveled through the same access network.

3. The method for updating at least two tables as claimed in claim 1, comprising at least one act of deleting the row from the table, after expiry of a lifetime of the pheromonal message received.

4. The method for updating at least two tables as claimed in claim 3, where a remaining lifetime of the pheromonal message begins to decrease at the moment of its sending by the second terminal, and where the pheromonal message comprises an item of information relating to the moment of its sending.

5. The method for updating at least two tables as claimed in claim 3, where a remaining lifetime of the pheromonal message begins to decrease at the moment of the reception act.

6. The method for updating at least two tables as claimed in claim 3, where all the pheromonal messages have a same initial remaining lifetime.

7. The method for updating at least two tables as claimed in claim 1, furthermore comprising an act of counting the number of rows per table, and an act of selecting one of the at least two access networks as a function of the counting.

8. The method for updating at least two tables as claimed in claim 1, furthermore comprising an act of counting the number of rows per table, and an act of sending an item of information relating to the counting, destined for the second terminal.

9. A method for sending a pheromonal message destined for a first terminal, implemented by a second terminal, the first terminal and the second terminal being linked in parallel by at least two access networks, the method comprising:
for each of the at least two access networks
at least one step act of sending the pheromonal message to the first terminal, the pheromonal message traveling through said one of the at least two access networks, and
repeating the sending act according to an identical frequency for the at least two access networks.

10. The method for sending a pheromonal message as claimed in claim 9, comprising a prior act of receiving a request for subscription to the pheromonal messages for the first terminal.

11. (canceled)

12. A first terminal (T1) connected to a plurality of access networks linking the first terminal in parallel to a second terminal, said first terminal comprising:
a processor;
at least one computer-readable medium comprising instructions stored thereon, which when executed by the processor configure the processor to perform acts comprising:
storing in the at least one computer-readable medium a plurality of tables corresponding to the plurality of access networks,
receiving a message of a determined type, termed a pheromonal message, sent by the second terminal and having traveled through one of the access networks of the plurality,
analyzing content of the pheromonal message received, and
adding a row to the table corresponding to the access network of travel of the pheromonal message received, as a function of the analysis.

13. A second terminal connected to a plurality of access networks linking the second terminal in parallel to a first terminal, said second terminal comprising:
a processor;
at least one computer-readable medium comprising instructions stored thereon, which when executed by the processor configure the processor to perform acts comprising:
sending a pheromonal message to the first terminal through each of the access networks of the plurality, and
repeating the sending according to an identical frequency for the at least two access networks.

14. (canceled)

15. (canceled)
